(19) United States
(12) Patent Application Publication
(10) Pub. No.: US 2012/0169313 A1
(43) Pub. Date: Jul. 5, 2012

(54) SWITCH CONTROL CIRCUIT, CONVERTER USING THE SAME, AND SWITCH CONTROL METHOD

(76) Inventors: Jae-yong LEE, Seongnam (KR); Byung-Kwon CHOI, Bucheon (KR); Young-Je LEE, Bucheon (KR); Seung-Woo HONG, Seoul (KR)

(21) Appl. No.: 13/328,669

(22) Filed: Dec. 16, 2011

(30) Foreign Application Priority Data
Jan. 3, 2011 (KR) 10-2011-0000258

(51) Int. Cl. G05F 1/12

(52) U.S. Cl. 323/282

(57) ABSTRACT

The present invention relates to a switch control circuit, a switch control method, and a converter using the same. An input voltage of a converter is provided to an inductor, and an output voltage is generated by an inductor current caused by the input voltage. A switch control circuit for controlling a switching operation of a power switch connected to the inductor to control the inductor current senses a drain current flowing to the power switch while the power switch is turned on, and controls a slope of a sawtooth wave signal for determining a turn-off time of the power switch according to the sensed drain current.

### CROSS-REFERENCE TO RELATED APPLICATION

This application claims priority to and the benefit of Korean Patent Application No. 10-2011-0000258 filed in the Korean Intellectual Property Office on Jan. 3, 2011, the entire contents of which are incorporated herein by reference.

### BACKGROUND

(a) Field

Embodiments of the present invention relate to a converter and a driving method thereof. Particularly, Embodiments of the present invention relates to a switch control circuit for optimizing total harmonic distortion, a converter using the same, and a switch control method.

(b) Description of the Related Art

A zero current detecting configuration is required to control a switching operation of a converter switch configuring a power factor correction circuit. The zero current detection represents detecting the time when the current flowing to an inductor of a converter becomes 0. The converter is designed to turn on the switch when the current flowing to the inductor becomes 0.

A conventional power factor correction converter uses an auxiliary coil coupled to an inductor of a converter in an insulated manner with a predetermined turn ratio so as to detect the zero current. A control circuit of the converter includes an additional pin, and is connected to an auxiliary coil to receive a zero current detecting voltage that corresponds to a voltage at the inductor. The converter control circuit detects the time when the inductor current becomes zero by using the zero current detecting voltage, and turns on the switch at that time.

Differing from this, a converter control circuit including no additional pin for detecting the zero current directly senses the current flowing to the inductor so as to detect the zero current. When a voltage (hereinafter, sense voltage) used to sense the current flowing to the inductor becomes the zero voltage, the converter control circuit turns on the switch. However, the above-noted method generates a reverse current interval in which the current of the inductor flows in the negative direction. When the switch is turned on before the time when the sense voltage becomes the zero voltage, a current spike occurs at the switch since the current flows to a diode connected to an output end. Therefore, an additional leading edge blanking (LEB) circuit is needed so as to prevent such hard switching.

In order to prevent hard switching without an additional LEB circuit, resonance is needed between a parasitic capacitor of a MOSFET functioning as a switch and the inductor of the converter. The soft switching is performed by dropping a drain voltage of the MOSFET by resonance. In this instance, a reverse current is generated at the switch because of resonance. That is, the switch is turned on during the reverse current interval for the soft switching.

When the reverse current occurs, it is weak in total harmonic distortion. The method for using a zero current detecting pin uses a voltage that occurs at an auxiliary coil so as to optimize the total harmonic distortion. The method for using a sense voltage has a difficulty in optimizing the total harmonic distortion because it uses no auxiliary coil.

The above information disclosed in this Background section is only for enhancement of understanding of the background of the invention and therefore it may contain information that does not form the prior art that is already known in this country to a person of ordinary skill in the art.

### SUMMARY OF THE INVENTION

Embodiments of the present invention has been made in an effort to provide a switch control circuit for controlling a switching operation without a pin for detecting a zero current, and a switch control method.

Embodiments of the present invention has been made in another effort to provide a converter for optimizing total harmonic distortion without an additional auxiliary coil by using the switch control circuit and the switch control method.

An exemplary embodiment of the present invention provides a converter for generating output power according to an inductor current caused by an input voltage transmitted to an inductor.

The converter includes: a power switch connected to the inductor to control the inductor current; and a switch control circuit for sensing a drain current flowing to the power switch while the power switch is turned on, and controlling a slope of a sawtooth wave signal for determining a turn-off time of the power switch according to the sensed drain current.

The switch control circuit controls the slope of the sawtooth wave signal by generating a compensated current corresponding to the sensed drain current.

A first end of the power switch is grounded and a second end of the power switch is connected to the inductor, and the converter further includes a sense resistor connected between the first end of the power switch and an input pin of the switch control circuit so as to sense the drain current.

The switch control circuit includes a compensated current generator for inverting the sense voltage transmitted to the input pin, shifting the inverted voltage with respect to a predetermined shift reference voltage, sampling the shifted voltage after a predetermined delay interval after the power switch is turned on, amplifying the sampled voltage, and converting the amplified voltage into a current to thus generate the compensated current.

The compensated current generator includes: an inverting level shifter for inverting the sense voltage, and level shifting the inverted sense voltage with respect to the shift reference voltage to thereby generate the shifted voltage; a sample and hold unit for generating the sampling voltage by sampling the shifted voltage after the delay interval after the turn-on time of the power switch, and holding the sampling voltage at least until the turn-off time of the power switch; an amplifying unit for generating an amplified voltage by amplifying the sampling voltage; and a voltage/current converter for generating the compensated current by converting the amplified voltage into a current.

The inverting level shifter includes: a first resistor including a first end for receiving the sense voltage; an amplifier including an inverting terminal connected to a second end of the first resistor and a non-inverting terminal for receiving the shift reference voltage; and a second resistor connected to the inverting terminal of the amplifier and an output end of the amplifier.

The sample and hold unit includes: a first sampling switch for receiving the shifted voltage; a first capacitor connected to a second end of the first sampling switch; a first amplifier including an inverting terminal connected to the first capacitor and a non-inverting terminal for receiving a predetermined sampling reference voltage; a second capacitor connected between the inverting terminal of the first amplifier and the output end of the first amplifier; a holding switch connected between a first end of the first capacitor and the ground unit; and a second sampling switch connected in parallel to the second capacitor.

The first and second sampling switches are turned off after the delay interval after the power switch is turned on, and the holding switch is turned on to sample the shifted voltage and is held until the power switch is turned off.

The first and second sampling switches are turned on when the power switch is turned off and the holding switch is turned off to thereby set the sampling voltage to be the sampling reference voltage.

The current/voltage converter includes: an amplifier including a non-inverting terminal for receiving the amplified voltage; a first transistor having a gate electrode connected to the output end of the amplifier; a first resistor having a first end connected to the first transistor; and a current mirror for generating the compensated current by mirroring a current of the first transistor.

The first end of the first resistor is connected to the inverting terminal of the amplifier.

The switch control circuit further includes a sawtooth wave signal generator for generating the sawtooth wave signal by charging a capacitor by the compensated current and a constant current and discharging the capacitor in synchronization with the turn-off time of the power switch.

The switch control circuit generates an error signal by amplifying a difference between a feedback voltage corresponding to a voltage of the output power and a predetermined reference voltage, and determining a turn-off time of the power switch by comparing the error signal and the sawtooth wave signal.

Another exemplary embodiment of the present invention provides a switch control circuit for controlling a switching operation of a power switch for controlling an inductor current flowing to an inductor according to an input voltage.

The switch control circuit includes: a compensated current generator for sensing a drain current flowing to the power switch while the power switch is turned on, and generating a compensated current corresponding to the sensed drain current by using the sensed drain current; and a sawtooth wave signal generator for generating a sawtooth wave signal for determining a turn-off time of the power switch by using the compensated current.

The compensated current generator includes: an inverting level shifter for inverting a sense voltage occurring in a sense resistor connected to the power switch and the ground, and level shifting the inverted sense voltage with respect to a predetermined shift reference voltage to a shifted voltage; a sample and hold unit for generating a sampling voltage by sampling the shifted voltage after a predetermined delay interval after the power switch is turned on, and holding the sampling voltage at least until the time when the power switch is turned off; an amplifying unit for generating an amplified voltage by amplifying the sampling voltage; and a voltage/current converter for generating the compensated current by converting the amplified voltage into a current.

The inverting level shifter includes: a first resistor including a first end for receiving the sense voltage; an amplifier including an inverting terminal connected to a second end of the first resistor and a non-inverting terminal for receiving the shift reference voltage; and a second resistor connected to the inverting terminal of the amplifier and an output end of the amplifier.

The sample and hold unit includes: a first sampling switch that is turned off in synchronization with a first time that is provided after the delay interval after the power switch is turned on; a first capacitor connected to a second end of the first sampling switch; a first amplifier including an inverting terminal connected to the first capacitor and a non-inverting terminal for receiving a predetermined sampling reference voltage; a second capacitor connected between the inverting terminal of the first amplifier and the output end of the first amplifier; a holding switch connected between a first end of the first capacitor and the ground unit, and turned on at the first time; and a second sampling switch connected in parallel to the second capacitor and turned on at the first time, wherein the turn-on periods of the first and second sampling switches are not overlapped with the turn-on period of the holding switch.

The current/voltage converter includes: an amplifier including a non-inverting terminal for receiving the amplified voltage; a first transistor having a gate electrode connected to the output end of the amplifier; a first resistor to which a current of the first transistor flows; a second resistor connected in series with the first resistor; and a current mirror for generating the compensated current by mirroring the current of the first transistor, the inverting terminal of the amplifier being connected to a node of the first resistor and the second resistor.

Another embodiment of the present invention provides a method for controlling a switching operation of a power switch for controlling an inductor current flowing to an inductor according to an input voltage.

The method includes: sensing a drain current flowing to the power switch while the power switch is turned on, and generating a compensated current corresponding to the sensed drain current according to the sensed drain current; and generating a sawtooth wave signal for determining a turn-off time of the power switch by using the compensated current.

The generating of a compensated current includes: inverting a sense voltage occurring at a sense resistor connected to the power switch and a ground unit, and level shifting the inverted sense voltage with respect to a predetermined shift reference voltage to generate a shifted voltage; generating a sampling voltage by sampling the shifted voltage in synchronization with the turn-on time of the power switch, and holding the sampling voltage until at least the turn-off time of the power switch; amplifying the sampling voltage; and generating the compensated current by converting the amplified voltage into a current.

The generating of a sawtooth wave signal includes: charging a capacitor by the compensated current and a constant current; and discharging the capacitor in synchronization with the turn-off time of the power switch.

According to the embodiment of the present invention, a switch control circuit for controlling the switching operation of the converter without an additional auxiliary coil and a pin for detecting the zero current and optimizing total harmonic distortion, a switch control method, and a converter are provided.

### BRIEF DESCRIPTION OF THE DRAWINGS

FIG. 1 shows a converter according to an exemplary embodiment of the present invention.

FIG. 2 shows an inductor current according to a switching operation by a power switch.

FIG. 3 shows a switch control circuit according to an exemplary embodiment of the present invention.

FIG. 4 shows a compensated current generator according to an exemplary embodiment of the present invention.

FIG. 5 shows an on/off time of a sampling switch, and an on/off time, a shifted voltage, a sampling voltage, and a sense voltage of a holding switch.

FIG. 6 shows an input voltage and an on-time of a power switch with respect to time.

FIG. 7 shows a shifted voltage, a sense voltage, a compensated current, and a sawtooth wave signal according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout this specification and the claims that follow, when it is described that an element is “coupled” to another element, the element may be “directly coupled” to the other element or “electrically coupled” to the other element through a third element. In addition, unless explicitly described to the contrary, the word “comprise” and variations such as “comprises” or “comprising” will be understood to imply the inclusion of stated elements but not the exclusion of any other elements.

The present invention will be described more fully hereinafter with reference to the accompanying drawings, in which exemplary embodiments of the invention are shown.

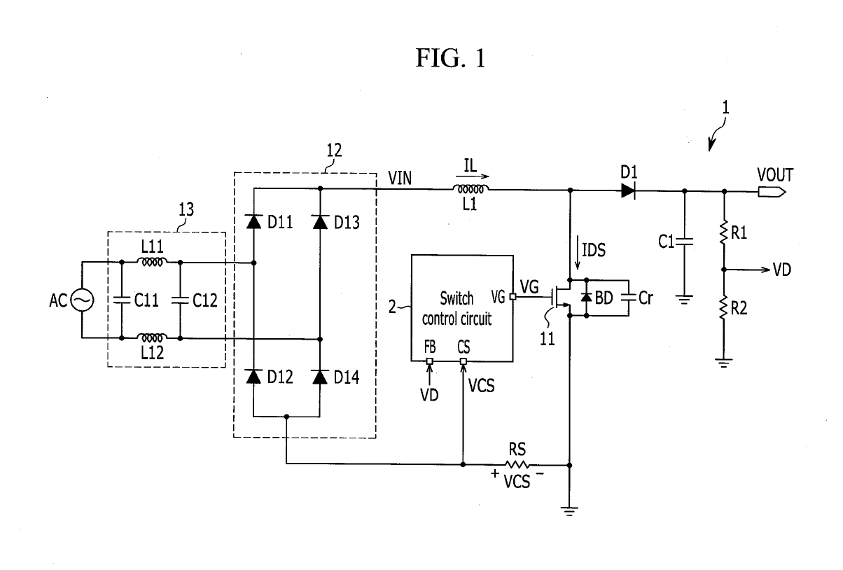

FIG. 1 shows a converter 1 according to an exemplary embodiment of the present invention. A power factor correction circuit will be realized with a boost converter in an exemplary embodiment of the present invention. However, the present invention is not limited thereto.

As shown in FIG. 1, the converter 1 includes a switch control circuit 2, a power switch 11, a bridge diode 12, a line filter 13, a diode D1, a capacitor C1, an inductor L1, and dividing resistors R1 and R2. The power switch 11 includes an n-channel metal oxide semiconductor field effect transistor (NMOSFET). A body diode (BD) and a parasitic capacitor (Cr) are formed between a drain electrode and a source electrode of the power switch 11. A current flowing to the power switch 11 will be called a drain current (IDS).

The bridge diode 12 includes four diodes (D11-D14), and generates an input voltage (Vin) by full-wave rectifying an input AC power (AC). An output end of the bridge diode 12 is connected to a first end of the inductor L1. The bridge diode 12 is grounded through a sense resistor (RS).

The line filter 13 includes capacitors C11 and C12 connected in parallel to both ends to which the input AC power (AC) is applied, and inductors L11 and L12 connected in series to both ends of the input AC power (AC). The line filter 13 filters electromagnetic interference of the input AC power (AC).

An input voltage (Vin) is supplied to a first end of the inductor L1, and a second end of the inductor L1 is connected to an anode of the diode D1 and a drain of the power switch 11. A cathode of the power switch 11 is grounded, and a gate voltage (VG) output by the switch control circuit 2 is provided to a gate of the power switch 11.

A sense resistor (RS) is connected between a source of the power switch 11 and an input pin (CS) of the switch control circuit 2, and a sense voltage (VCS) is input to the switch control circuit 2 through the input pin (CS). The switch control circuit 2 detects the zero current by using the sense voltage (VCS). A first end of the sense resistor (RS) is grounded, a second end thereof is connected to the input pin (CS), and the sense voltage (VCS) represents the voltage at the second end of the sense resistor (RS). The drain current (IDS) flows from the first end of the sense resistor (RS) to the second end so the sense voltage (VCS) is a negative voltage.

The input voltage (VIN) is provided to the inductor L1, and an output power is generated by a current (hereinafter, inductor current) flowing to the inductor L1 according to the input voltage (VIN). The inductor current (IL) is controlled by the switching operation of the power switch 11.

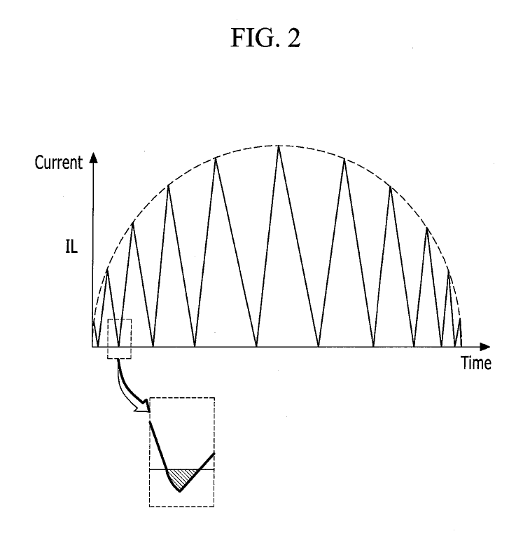

FIG. 2 shows an inductor current according to a switching operation by a power switch.

As shown in FIG. 2, the inductor current has a sawtooth waveform which is repeatedly increased and decreased, and in detail, it is increased while the power switch 11 is turned on and it is decreased while the power switch 11 is turned off.

In further detail, while the power switch 11 is turned on, the inductor current (IL) is increased and the inductor L1 stores energy. While the power switch 11 is turned off, the inductor current (IL) flows through the diode D1, and the energy stored in the inductor L1 is provided to the output end of the converter 1. When the power switch 11 is turned off and the diode D1 is turned on, the inductor current (IL) flows to a load that is connected to an output end of the power factor correction circuit 1 and charges the capacitor C1. As the load connected to the output end of the power factor correction circuit 1 is increased, the inductor current (IL) supplied to the load is also increased so the current flowing to the capacitor C1 is relatively decreased and the output voltage (Vout) is also relatively decreased. On the contrary, when the load is decreased, the inductor current (IL) supplied to the load is decreased so the current flowing to the capacitor C1 is relatively increased and the output voltage (Vout) is relatively increased.

By the above-described operation, the output voltage (Vout) is maintained irrespective of the change of the load.

When the energy of the inductor L1 is supplied to the load, the diode D1 is intercepted. The drain voltage of the power switch 11 is reduced because of resonance between the inductor L1 and the parasitic capacitor (Cr). After the drain voltage is reduced, the power switch 11 is turned on and the inductor current (IL) flows through the power switch 11. Therefore, the drain current (IDS) is increased like the inductor current (IL). While the power switch 11 is turned off, the drain current (IDS) is reduced by the resonance between the inductor L1 and the parasitic capacitor (Cr). The drain current (IDS) flows to the input AC power (AC) through the sense resistor (RS).

The switch control circuit 2 generates an error amplified signal (Vcon) by using a feedback voltage (VD) that is generated by dividing the output voltage (Vout) according to the resistance ratio (R2/(R1+R2)) of the dividing resistors R1 and R2, and determines a turn-off time of the power switch 11 by comparing the error amplified signal (VCON) and a sawtooth wave signal (VSAW) that rises with a slope that is determined by the sense voltage (VCS). The turn-on time of the power switch 11 is determined by the time when the sense voltage (VCS) reaches the zero voltage. The feedback voltage (VD) is input to an input pin (FB) of the switch control circuit 2.

A peak value of the inductor current shown with dotted lines in FIG. 2 is controlled to have the same waveform as the input voltage (VIN). That is, the slope of the inductor current is reduced as the input voltage is reduced, and the slope is increased as the input voltage is increased.

The switch control circuit 2 controls switching frequency and duty of the power switch 11 in consideration of the input voltage (VIN). The peak value of the inductor current is controlled by the input voltage (VIN), and the input current (i.e., an average of the inductor current) has the same waveform as the input voltage (VIN) to match the phases and improve the power factor.

FIG. 2 indicates the section in which the above-noted inductor current flows in the negative direction as a shaded region. The embodiment of the present invention provides a switch control method for compensating the inductor current that flows in the negative direction.

The switch control circuit 2 generates a gate signal for turning on the power switch 11 when the sense voltage (VCS) reaches the zero voltage. In this instance, the switch control circuit 2 determines the rising slope of the sawtooth wave signal (VSAW) according to the sense voltage (VCS).

The slope of the drain current (IDS) that flows while the power switch 11 is turned on is determined by the ratio (VIN/L1) of the input voltage (VIN) and inductance of the inductor L1. Therefore, when the sense voltage (VCS) is sensed, the input voltage (VIN) can be known. The switching frequency and the duty of the power switch 11 can be controlled according to the input voltage (VIN) by using the above-described point in the exemplary embodiment of the present invention.

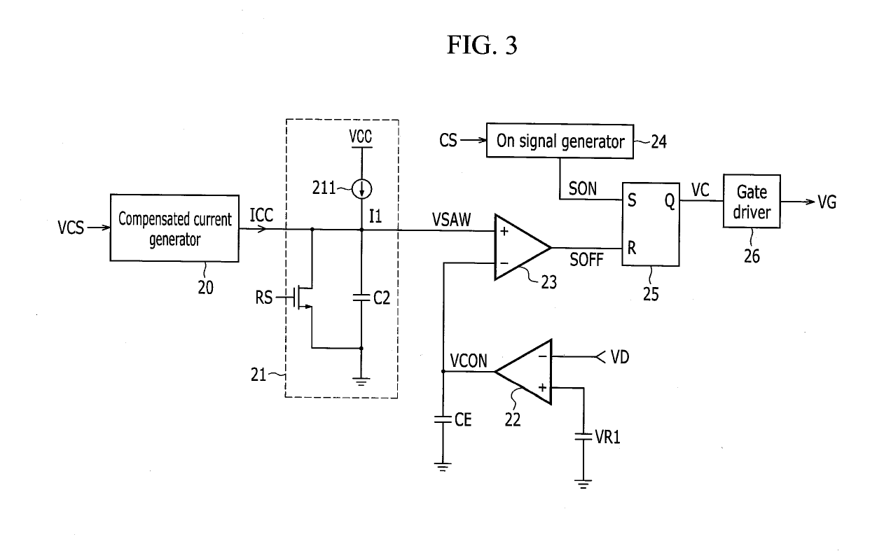

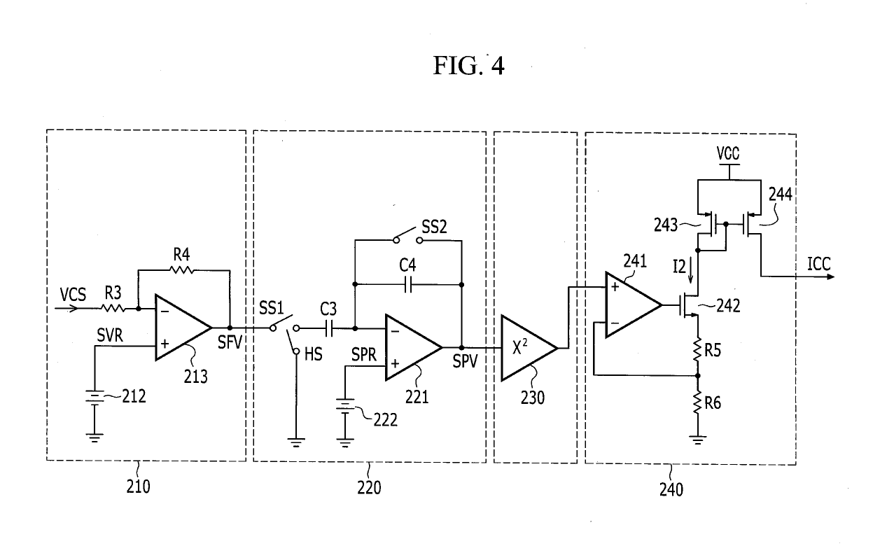

A detailed operation of the switch control circuit 2 will now be described with reference to FIG. 3 and FIG. 4.

FIG. 3 shows a switch control circuit 2 according to an exemplary embodiment of the present invention.

As shown in FIG. 3, the switch control circuit 2 includes a compensated current generator 20, a sawtooth wave signal generator 21, an error amplifier 22, a PWM comparator 23, an on-signal generator 24, an SR latch 25, and a gate driver 26.

The sawtooth wave signal generator 21 receives a compensated current (ICC) to generate a sawtooth wave signal (VSAW) having a rising slope according to the compensated current (ICC). The sawtooth wave signal generator 21 includes a constant current source 211, a discharge switch (DS), and a capacitor C2. A power voltage (VCC) supplies a voltage for the constant current source 211 to generate a current I1.

The discharge switch (DS) includes a gate electrode for transmitting a reset signal (RS), and is connected in parallel to the capacitor C2. The drain electrode of the discharge switch (DS) is connected to a first end of the capacitor C2, and the source electrode of the discharge switch (DS) is connected to a second end of the capacitor C2.

The first end of the capacitor C2 is connected to the constant current source 211, and the second end thereof is grounded. The voltage signal charged in the capacitor C2 is the sawtooth wave signal (VSAW), and is connected to a non-inverting terminal (+) of the PWM comparator 23.

The capacitor C2 is charged by the current I1 supplied by the constant current source 211 and the compensated current (ICC). The compensated current (ICC) is variable by the input voltage (VIN) in synchronization with the switching cycle of the power switch 11. Therefore, the rising slope of the sawtooth wave signal (VSAW) charged in and generated by the capacitor C2 is changed by the input voltage (VIN) in synchronization with the switching cycle of the power switch 11.

When the sawtooth wave signal (VSAW) reaches the error signal (VCON), the PWM comparator 23 generates an off signal (SOFF). The off signal (SOFF) according to the exemplary embodiment of the present invention is a high level pulse. The discharge switch (DS) is turned on by the reset signal (RS) that is generated in synchronization with the time when the off signal (SOFF) is generated, and the capacitor C2 is discharged so the sawtooth wave signal (VSAW) becomes a ground voltage. The error amplifier 22 amplifies the error of the feedback voltage (VF) and the reference voltage VR1 with the current to generate an error signal (VCON). The error amplifier 22 includes an inverting terminal (−) to which a feedback voltage (VF) is input and a non-inverting terminal (+) to which the reference voltage VR1 is input. The error amplifier 22 amplifies the voltage that is generated by subtracting the feedback voltage (VF) from the reference voltage VR1 with a predetermined gain to generate an error signal (VCON). The error amplifier 22 amplifies the voltage difference between the reference voltage VR1 and the feedback voltage (VF) to generate a current which is charged in the capacitor (CE). The voltage charged in the capacitor (CE) is the voltage of the error signal (VCON).

The PWM comparator 23 includes an inverting terminal (−) to which the error signal (VCON) is input and a non-inverting terminal (+) to which the sawtooth wave signal (VSAW) is input. The PWM comparator 230 generates a high-level off signal (SOFF) when the sawtooth wave signal (VSAW) reaches the error signal (VCON).

When the load of the converter 1 is increased to reduce the output voltage (VOUT), the feedback voltage (VF) is also reduced to increase the error signal (VCON). On the contrary, when the load is reduced to increase the output voltage (VOUT), the feedback voltage (VF) is increased to reduce the error signal (VCON). As the error signal (VCON) is increased, the time for the sawtooth wave signal (VSAW) to reach the error signal (VCON) is increased so the on time of the power switch 11 is increased. As the error signal (VCON) is decreased, the time for the sawtooth wave signal (VSAW) to reach the error signal (VCON) is reduced so the on-time of the power switch 11 is reduced.

In this instance, the slope of the sawtooth wave signal (VSAW) is determined by the input voltage (VIN) so the on-time is reduced as the input voltage (VIN) becomes greater and it is increased as the input voltage (VIN) becomes lesser under the same error signal (VCON) condition.

The compensated current generator 20 inverts the sense voltage (VCS), shifts the same with respect to a predetermined shift reference voltage, samples the shifted voltage (SFV) in synchronization with the turn-on time of the power switch 11, and holds it. In detail, the compensated current generator 20 samples and holds the shifted voltage (SFV) after a predetermined delay interval starting from the turn-on time of the power switch 11.

The compensated current generator 20 amplifies the sampled voltage (SPV) and converts the amplified voltage (AMV) into the current to generate the compensated current (ICC). A configuration of the compensated current generator 20 will now be described with reference to FIG. 4.

FIG. 4 shows a compensated current generator according to an exemplary embodiment of the present invention.

As shown in FIG. 4, the compensated current generator 20 includes an inverting level shifter 210, a sample and hold unit 220, an amplifying unit 230, and a voltage/current converter 240.

The inverting level shifter 210 inverts the sense voltage (VCS) and level shifts the inverted sense voltage (VCS) with respect to the shift reference voltage (SVR) to generate a shifted voltage (SFV).

The inverting level shifter 210 includes an amplifier 213, a reference voltage source 212, a resistor R3, and a resistor R4.

The resistor R3 includes a first end to which the sense voltage (VCS) is input and a second end connected to the inverting terminal (−) of the amplifier 213. The resistor R4 includes a first end connected to the inverting terminal (−) of the amplifier 213 and a second connected to an output end of the end amplifier 213.

The amplifier 213 includes a non-inverting terminal (+) connected to the reference voltage source 212, and the reference voltage source 212 generates a shift reference voltage (SVR). The amplifier 213 outputs the voltage (SVR+(SVR−VCS)/(R4/R3)) that is generated by dividing the difference between the shifted voltage (SVR) and the sense voltage (VCS) by the resistor ratio (R4/R3) and adding the shift reference voltage (SVR) as an output voltage, that is, the shifted voltage (SFV). The sense voltage (VCS) is a negative voltage so it is difficult for the switch control circuit 2 to use the sense voltage (VCS). Also, when the inverted sense voltage has a low level, it may be difficult to use the switch control circuit 2. In consideration of the above-noted point, the inverting level shifter 210 inverts the sense voltage (VCS) and level-shifts the same.

The sample and hold unit 220 samples the shifted voltage (SFV) in synchronization with the time when the power switch 11 is turned on to generate a sampling voltage (SPV), and holds the sampling voltage (SPV). In detail, the sample and hold unit 220 generates the sampling voltage (SPV) by sampling the shifted voltage (SFV) at the time after a delay interval from the time when the power switch 11 is turned on, and it holds the same until the power switch 11 is turned off.

The period for holding the sampling voltage (SPV) includes the time when the power switch 11 is turned off. That is, there is no need to hold the sampling voltage (SPV) after the turn-off time of the power switch 11 is determined by the compensated current (ICC) corresponding to the sampling voltage (SPV).

The termination time of the holding period is set to be the turn-off time of the power switch 11 in the exemplary embodiment of the present invention, and the present invention is not limited thereto. That is, the held voltage must be reset to be the sampling reference voltage (SPR) before the next sampling time.

The sample and hold unit 220 includes an amplifier 221, a reference voltage source 222, sampling switches SS1 and SS2, a holding switch (HS), and capacitors C3 and C4.

The sampling switch SS1 includes a first end to which the shifted voltage (SFV) is input and a second end connected to the capacitor C3. The capacitor C3 includes a first end connected to the sampling switch SS1 and a second end connected to an inverting terminal (−) of the amplifier 221. The capacitor C4 includes a first end connected to an inverting terminal (−) of the amplifier 221 and a second end connected to an output end of the amplifier 221. The sampling switch SS2 is connected in parallel to the capacitor C4.

The holding switch (HS) includes a first end connected to the first end of the capacitor C3 and a grounded second end. The reference voltage source 222 generates a sampling reference voltage (SPR) and transmits it to the non-inverting terminal (+) of the amplifier 221.

The sampling switch SS1 and the sampling switch SS2 are turned off and the holding switch (HS) is turned on after a predetermined delay interval starting from the turn-on time of the power switch 11, so the sampling voltage (SPV) is sampled and held. In detail, the shifted voltage (SFV) when sampling switches SS1 and SS2 are turned off is divided by the capacitance ratio of the capacitor C3 and the capacitor C4 to generate the sampling voltage (SPV). The sampling voltage (SPV) is held since the holding switch (HS) is turned on starting from the time when the sampling switches SS1 and SS2 are turned off.

When the power switch 11 is turned off, the sampling switches SS1 and SS2 are turned on, and the holding switch (HS) is turned off. A sampling standby period is defined to be a period from the turn-off time of the power switch 11 to the time that is provided after the delay interval from the turn-on time of the power switch 11.

During the sampling standby period, the voltage at the inverting terminal (−) of the amplifier 221 is maintained at the sampling reference voltage (SPR), the voltage at the non-inverting terminal (+). Hence, the sampling voltage (SPV) is the reference voltage (SPR) during the sampling standby period.

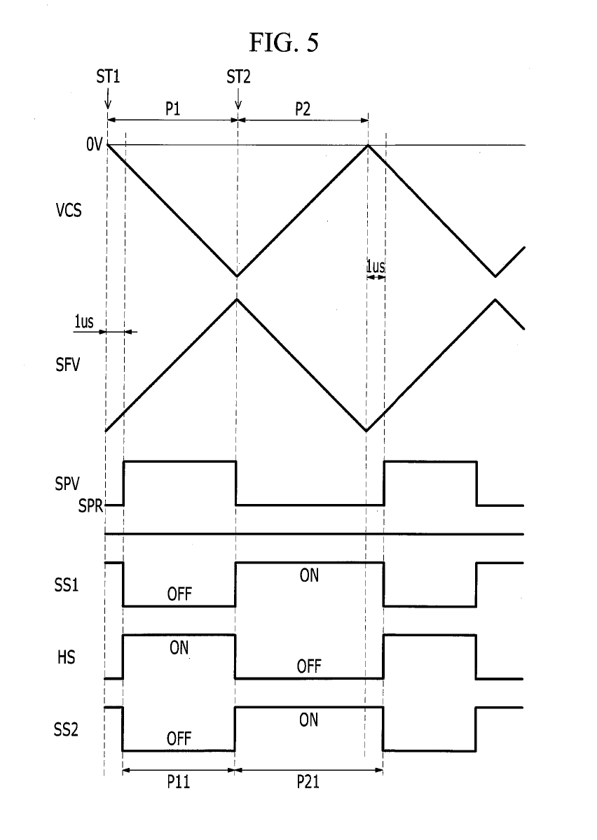

An operation of the sample and hold unit will now be described in detail with reference to FIG. 5.

FIG. 5 shows an on/off time of a sampling switch, and an on/off time, a shifted voltage, a sampling voltage, and a sense voltage of a holding switch.

The power switch 11 is turned on during the period P1 and it is turned off during the period P2.

As shown in FIG. 5, the sampling switches SS1 and SS2 are turned off and the holding switch (HS) is turned on at the time that is delayed by the delay interval (e.g., 1 us) from the turn-on time ST1 of the power switch 11.

The voltage that is generated by dividing the shifted voltage (SFV) when the sampling switches SS1 and SS2 are turned off according to the ratio of the capacitor C3 and capacitor C4 becomes the sampling voltage (SPV).

During the period P11, the sampling switches SS1 and SS2 are turned off and the holding switch (HS) is turned on so the sampling voltage (SPV) is held during the period P11 up to the turn-off time ST2 of the power switch 11.

When the power switch 11 is turned off at the time ST2, the sampling switches SS1 and SS2 are turned on and the holding switch (HS) is turned off. During the period P2, the power switch 11 is turned off.

The holding switch (HS) is turned off and the sampling switches SS1 and SS2 are turned on during the period P21 from the turn-off time ST2 of the power switch 11 to the time that lasts after the delay interval from the next turn-on time. The period P21 will be called a sampling standby period.

During the sampling standby period P21, the voltage at the inverting terminal (−) of the amplifier 221 is maintained at the sampling reference voltage (SPR), the voltage at the non-inverting terminal (+). Therefore, the sampling voltage (SPV) is the reference voltage (SPR) during the sampling standby period.

A signal for controlling the switching operation of the sampling switches SS1 and SS2 and the holding switch (HS) can be generated according to the on signal (SON) or the off signal (SOFF). That is, control signals for turning off the sampling switches SS1 and SS2 and turning on the holding switch (HS) after the delay interval from the time when the on signal (SON) is generated can be generated. Further, a rising edge of a gate control signal (VC) or a gate signal (VG) can be used instead of the on signal (SON).

In addition, control signals for turning off the holding switch (HS) and turning on the sampling switches SS1 and SS2 when the off signal (SOFF) is generated can be generated. A falling edge of the gate control signal (VC) or the gate signal (VG) can be used instead of the off signal (SOFF).

Accordingly, the respective turn-on periods of the sampling switches SS1 and SS2 and the holding switch (HS) are controlled to not be overlapped.

The amplifying unit 230 generates an amplified voltage (AMV) by squaring the sampling voltage (SPV). When a level of the sampling voltage (SPV) is appropriate for the input voltage of the voltage/current converter 240, the amplifying unit 230 may not be included. Also, the squaring operation is an example for amplification, and the present invention is not limited thereto.

The voltage/current converter 240 generates a compensated current (ICC) by converting the amplified voltage (AMV) into the current. As shown in FIG. 4, the voltage/current converter 240 includes a comparator 241, a plurality of transistors 242, 243, and 244, and a plurality of resistors R5 and R6. The voltage/current converter 240 may include one resistor R6 other than the two resistors R5 and R6.

The amplifier 241 includes a non-inverting terminal (+) to which an amplified voltage (AMV) is input and an inverting terminal (−) connected to a node of the resistor R5 and the resistor R6. An output end of the amplifier 241 is connected to a gate electrode of the transistor 242.

A source electrode of the transistor 242 is connected to a first end of the resistor R5, and a drain electrode of the transistor 242 is connected to a gate electrode and a drain electrode of the transistor 243. The transistor 244 having a gate electrode connected to the gate electrode of the diode-connected transistor 243 forms a current mirror with the transistor 243. The source electrodes of the transistors 243 and 244 are connected to the power voltage (VCC).

A first end of the resistor R6 is connected to a second end of the resistor R5, and a second end of the resistor R6 is grounded.

The amplifier 241 controls the turned on state of the transistor 242 so that the voltage of the amplified voltage (AMV) may correspond to the voltage at the inverting terminal (−), and thereby generates the current I1 that is variable by the amplified voltage (AMV). The current I1 flows to the transistor 243 so the current I1 is mirrored and transmitted to the transistor 244. The current flowing to the transistor 244 is the compensated current (ICC).

A current mirror ratio depends on ratios of channel length and channel width of the transistor 243 and the transistor 244. When the channel length/width ratios of the transistors 243 and 244 are the same, the current I1 corresponds to the compensated current (ICC).

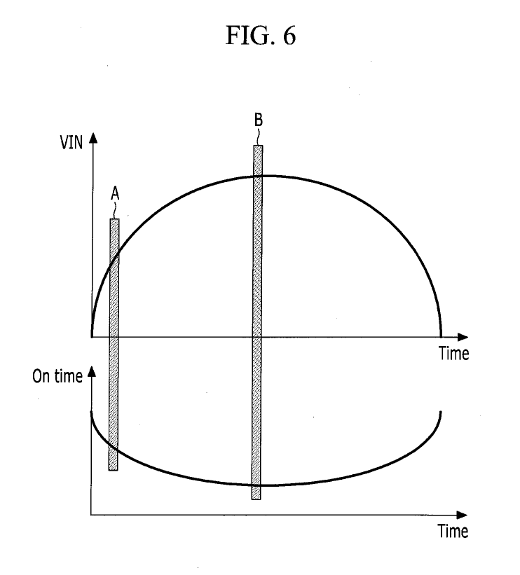

FIG. 6 shows an input voltage and an on-time of a power switch with respect to time.

As shown in FIG. 6, the on-time becomes longer as the input voltage (VIN) is lower, and the same becomes shorter as the input voltage (VIN) becomes higher.

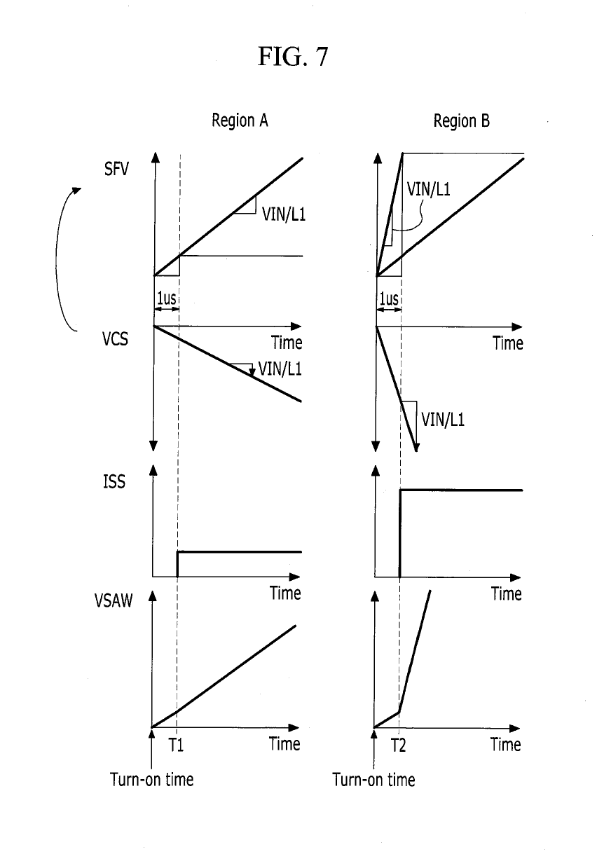

An operation of the compensated current generator 20 in the shaded region A and region B of FIG. 6 will now be described with reference to FIG. 7.

FIG. 7 shows a shifted voltage, a sense voltage, a compensated current, and a sawtooth wave signal according to an exemplary embodiment of the present invention.

As shown in FIG. 6, the input voltage (VIN) in the region A is lower than the input voltage (VIN) in the region B.

As shown in FIG. 7, the sense voltage (VCS) in the region A begins to be reduced in the negative voltage direction when the power switch 11 is turned on. The falling slope of the sense voltage (VCS) is proportional to the input voltage (VIN). When the sense voltage (VCS) is inverted and level-shifted, the shifted voltage (SFV) begins to be increased with the slope proportional to the input voltage (VIN).

The shifted voltage (SFV) is sampled at the time T1 that is after the turn-on time of the power switch 11 by the period of 1 us to thus generate a sampling voltage (SPV) and a compensated current (ICC). The capacitor C2 is charged by the current I1 of the sawtooth wave signal generator 21 until the time T1, and the compensated current (ICC) is added to the current I1 to charge the capacitor C2 from the time T1. Therefore, the rising slope of the sawtooth wave signal (VSAW) is increased by the compensated current (ICC) from the time T1.

As shown in FIG. 7, the sense voltage (VCS) in the region B starts to be reduced in the negative voltage direction starting from the turn-on time of the power switch 11. The falling slope of the sense voltage (VCS) is proportional to the input voltage (VIN). When the sense voltage (VCS) is inverted and level-shifted, the shifted voltage (SFV) starts to be increased with the slope that is proportional to the input voltage (VIN). As shown in FIG. 7, the falling slope of the sense voltage (VCS) and the rising slope of the shifted voltage (SFV) in the region B are greater than the falling slope of the sense voltage (VCS) and the rising slope of the shifted voltage (SFV) in the region A.

The shifted voltage (SFV) is sampled at the time T2 that is after the turn-on time of the power switch 11 by the period of 1 us to thereby generate a sampling voltage (SPV) and a compensated current (ICC). The capacitor C2 is charged by the current I1 of the sawtooth wave signal generator 21 until the time T2, and the compensated current (ICC) is added to the current I1 starting from the time T1 to charge the capacitor C2. Therefore, the rising slope of the sawtooth wave signal (VSAW) is steeply increased by the compensated current (ICC) starting from the time T1.

As shown in FIG. 7, since the sampling voltage (SPV) of the region B is greater than that of the region A, the compensated current (ICC) of the region B is also greater than that of the region A. Hence, the rising slope of the sawtooth wave signal (VSAW) of the region B is greater than that of the region A.

Accordingly, as the input voltage (VIN) becomes lower, the rising slope of the sawtooth wave signal (VSAW) becomes relatively reduced so the time for the sawtooth wave signal (VSAW) to reach the error signal (VCON) is increased. That is, as the input voltage (VIN) is higher, the added compensated current (ICC) is greater, so the rising slope of the sawtooth wave signal (VSAW) becomes steeper to relatively reduce the on-time, and as the input voltage (VIN) is lower, the added compensated current (ICC) is lesser so the slope of the sawtooth wave is gentle to relatively increase the on-time and compensate the amount of the inductor current flowing in the negative direction.

Compared to the conventional switch control circuit including the additional zero current detecting pin and using the auxiliary coil, the switch control circuit according to the exemplary embodiment of the present invention compensates the negative inductor current without using the zero current detecting pin and the auxiliary coil.

The on signal generator 24 generates an on signal (SON) for turning on the power switch 11 when the sense voltage (VCS) has reached the zero voltage. The on signal (SON) is a high-level pulse signal.

The SR latch 25 includes a set end (S) to which the on signal (SON) is input, a reset end (R) to which the off signal (SOFF) is input, and an output end (Q) for outputting the gate control signal (VC). The SR latch 25 outputs a high-level signal through the output end (Q) in synchronization with the rising edge of the signal that is input to the set end (S), and it outputs a low-level signal in synchronization with the rising edge of the signal that is input to the reset end (R). When the inputs to the set end (S) and the reset end (R) are low-level, the SR latch 25 maintains the current output.

Therefore, the SR latch 25 outputs a high-level gate control signal (VC) when an on signal (SON) is generated, and it outputs a low-level gate control signal (VC) when an off signal (SOFF) is generated.

The gate driver 26 generates a high-level gate signal (VG) according to the high-level gate control signal (VC) and generates a low-level gate signal (VG) according to the low-level gate control signal (VC). Therefore, when the on signal (SON) occurs, the power switch 11 is turned on by the high-level gate signal (VG), and when the off signal (SOFF) occurs, the power switch Ills turned off by the low-level gate signal (VG).

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A converter for generating output power according to an inductor current caused by an input voltage transmitted to an inductor, comprising:
a power switch connected to the inductor to control the inductor current; and
a switch control circuit for sensing a drain current flowing to the power switch while the power switch is turned on, and controlling a slope of a sawtooth wave signal for determining a turn-off time of the power switch according to the sensed drain current.

2. The converter of claim 1, wherein
the switch control circuit controls the slope of the sawtooth wave signal by generating a compensated current corresponding to the sensed drain current.

3. The converter of claim 2, wherein
a first end of the power switch is grounded and a second end of the power switch is connected to the inductor, and
the converter further includes a sense resistor connected between the first end of the power switch and an input pin of the switch control circuit so as to sense the drain current.

4. The converter of claim 3, wherein
the switch control circuit includes a compensated current generator for inverting the sense voltage transmitted to the input pin, shifting the inverted voltage with respect to a predetermined shift reference voltage, sampling the shifted voltage after a predetermined delay interval after the power switch is turned on, amplifying the sampled voltage, and converting the amplified voltage into a current to thus generate the compensated current.

5. The converter of claim 4, wherein
the compensated current generator includes:
an inverting level shifter for inverting the sense voltage, and level shifting the inverted sense voltage with respect to the shift reference voltage to thereby generate the shifted voltage;
a sample and hold unit for generating the sampling voltage by sampling the shifted voltage after the delay interval after the turn-on time of the power switch, and holding the sampling voltage at least until the turn-off time of the power switch;
an amplifying unit for generating an amplified voltage by amplifying the sampling voltage; and
a voltage/current converter for generating the compensated current by converting the amplified voltage into a current.

6. The converter of claim 5, wherein
the inverting level shifter includes:
a first resistor including a first end for receiving the sense voltage;
an amplifier including an inverting terminal connected to a second end of the first resistor and a non-inverting terminal for receiving the shift reference voltage; and
a second resistor connected to the inverting terminal of the amplifier and an output end of the amplifier.

7. The converter of claim 5, wherein
the sample and hold unit includes:
a first sampling switch for receiving the shifted voltage;
a first capacitor connected to a second end of the first sampling switch;
a first amplifier including an inverting terminal connected to the first capacitor and a non-inverting terminal for receiving a predetermined sampling reference voltage;
a second capacitor connected between the inverting terminal of the first amplifier and the output end of the first amplifier;
a holding switch connected between a first end of the first capacitor and the ground unit; and
a second sampling switch connected in parallel to the second capacitor.

8. The converter of claim 7, wherein
the first and second sampling switches are turned off after the delay interval after the power switch is turned on, and the holding switch is turned on to sample the shifted voltage and is held until the power switch is turned off.

9. The converter of claim 8, wherein
the first and second sampling switches are turned on when the power switch is turned off and the holding switch is turned off to thereby set the sampling voltage to be the sampling reference voltage.

10. The converter of claim 5, wherein
the current/voltage converter includes:
an amplifier including a non-inverting terminal for receiving the amplified voltage;
a first transistor having a gate electrode connected to the output end of the amplifier;
a first resistor having a first end connected to the first transistor; and
a current mirror for generating the compensated current by mirroring a current of the first transistor,
the first end of the first resistor being connected to the inverting terminal of the amplifier.

11. The converter of claim 2, wherein
the switch control circuit further includes a sawtooth wave signal generator for generating the sawtooth wave signal by charging a capacitor by the compensated current and a constant current and discharging the capacitor in synchronization with the turn-off time of the power switch.

12. The converter of claim 11, wherein
the switch control circuit generates an error signal by amplifying a difference between a feedback voltage corresponding to a voltage of the output power and a predetermined reference voltage, and determining a turn-off time of the power switch by comparing the error signal and the sawtooth wave signal.

13. A switch control circuit for controlling a switching operation of a power switch for controlling an inductor current flowing to an inductor according to an input voltage, comprising:
a compensated current generator for sensing a drain current flowing to the power switch while the power switch is turned on, and generating a compensated current corresponding to the sensed drain current by using the sensed drain current; and
a sawtooth wave signal generator for generating a sawtooth wave signal for determining a turn-off time of the power switch by using the compensated current.

14. The switch control circuit of claim 13, wherein
the compensated current generator includes:
an inverting level shifter for inverting a sense voltage occurring in a sense resistor connected to the power switch and the ground, and level shifting the inverted sense voltage with respect to a predetermined shift reference voltage to a shifted voltage;
a sample and hold unit for generating a sampling voltage by sampling the shifted voltage after a predetermined delay interval after the power switch is turned on, and holding the sampling voltage at least until the time when the power switch is turned off;
an amplifying unit for generating an amplified voltage by amplifying the sampling voltage; and
a voltage/current converter for generating the compensated current by converting the amplified voltage into a current.

15. The switch control circuit of claim 14, wherein
the inverting level shifter includes:
a first resistor including a first end for receiving the sense voltage;
an amplifier including an inverting terminal connected to a second end of the first resistor and a non-inverting terminal for receiving the shift reference voltage; and
a second resistor connected to the inverting terminal of the amplifier and an output end of the amplifier.

16. The switch control circuit of claim 14, wherein
the sample and hold unit includes:
a first sampling switch that is turned off in synchronization with a first time that is provided after the delay interval after the power switch is turned on;
a first capacitor connected to a second end of the first sampling switch;
a first amplifier including an inverting terminal connected to the first capacitor and a non-inverting terminal for receiving a predetermined sampling reference voltage;
a second capacitor connected between the inverting terminal of the first amplifier and the output end of the first amplifier;
a holding switch connected between a first end of the first capacitor and the ground unit, and turned on at the first time; and
a second sampling switch connected in parallel to the second capacitor and turned on at the first time,
wherein the turn-on periods of the first and second sampling switches are not overlapped with the turn-on period of the holding switch.

17. The switch control circuit of claim 14, wherein
the current/voltage converter includes:
an amplifier including a non-inverting terminal for receiving the amplified voltage;
a first transistor having a gate electrode connected to the output end of the amplifier;
a first resistor to which a current of the first transistor flows;
a second resistor connected in series with the first resistor; and
a current mirror for generating the compensated current by mirroring the current of the first transistor,
the inverting terminal of the amplifier being connected to a node of the first resistor and the second resistor.

18. A method for controlling a switching operation of a power switch for controlling an inductor current flowing to an inductor according to an input voltage, comprising:
sensing a drain current flowing to the power switch while the power switch is turned on, and generating a compensated current corresponding to the sensed drain current according to the sensed drain current; and
generating a sawtooth wave signal for determining a turn-off time of the power switch by using the compensated current.

19. The method of claim 18, wherein
the generating of a compensated current includes:
inverting a sense voltage occurring at a sense resistor connected to the power switch and a ground unit, and level shifting the inverted sense voltage with respect to a predetermined shift reference voltage to generate a shifted voltage;
generating a sampling voltage by sampling the shifted voltage in synchronization with the turn-on time of the power switch, and holding the sampling voltage until at least the turn-off time of the power switch;
amplifying the sampling voltage; and
generating the compensated current by converting the amplified voltage into a current.

20. The method of claim 19, wherein
the generating of a sawtooth wave signal includes:
charging a capacitor by the compensated current and a constant current; and
discharging the capacitor in synchronization with the turn-off time of the power switch.
